(19) United States
(12) Patent Application Publication
(10) Pub. No.: US 2022/0348442 A1
(43) Pub. Date: Nov. 3, 2022

(54) CONFINED SPACE TRIPOD PULLEY IMPROVEMENTS

(71) Applicant: Alexander Andrew, Inc. DBA Falltech, Compton, CA (US)

(72) Inventor: Zachary Winters, Los Angeles, CA (US)

(21) Appl. No.: 17/246,618

(22) Filed: May 1, 2021

(51) Int. Cl. B66C 5/02; B66D 3/04; B66C 23/16

(52) U.S. Cl. CPC B66C 5/025; B66D 3/04; B66C 23/166

(57) ABSTRACT

A pulley system for a confined space tripod includes a pulley including a pulley cavity having a first width and a second width. A pulley safety bracket is attached with the pulley. The pulley safety bracket includes a removable detent pin configured for placement above the pulley that prevents a pulley cable from dislodging from the pulley.

### BACKGROUND

### Field

The embodiments relate to fall protection confined space tripods, and in particular to fall protection confined space tripod systems and pulley improvements for different types of cables.

### Description of the Related Art

Workers that work in elevated environments may employ fall protection gear in certain confined spaces, such as a tripod system that may be employed as a portable anchor point for confined space uses when connected with winches and retractable equipment (e.g., to raise and lower various items and for rescue purposes).

### SUMMARY

Some embodiments relate to fall protection confined space tripod systems and pulley improvements for switching between different types of cables. One embodiment of the invention provides a pulley system for a confined space tripod includes a pulley including a pulley cavity having a first width and a second width. A pulley safety bracket is attached with the pulley. The pulley safety bracket includes a removable detent pin configured for placement above the pulley that prevents a pulley cable from dislodging from the pulley.

Other aspects and advantages of the present invention will become apparent from the following detailed description, which, when taken in conjunction with the drawings, illustrate by way of example the principles of the invention.

### BRIEF DESCRIPTION OF THE DRAWINGS

The embodiments are illustrated by way of example, and not by way of limitation, in the Figures of the accompanying drawings and in which like reference numerals refer to similar elements and in which:

FIG. 1 illustrates a tripod anchor system including a winch connected to a first pulley and a self-retracting (or retractive) lifeline (SRL) connected to a second pulley;

FIG. 2 illustrates a perspective view of a pulley bracket (or cable guard) with a removable detent pin, according to one embodiment of the invention;

FIG. 3 illustrates a front view of the pulley bracket with the removable detent pin of FIG. 2, according to one embodiment of the invention;

FIG. 4 illustrates a side view of an improved pulley that is employed with the pulley bracket of FIGS. 2 and 3, according to one embodiment of the invention;

FIG. 5 illustrates a view along section A-A of the improved pulley of FIG. 4, according to one embodiment of the invention; and

FIG. 6 shows a photographic view of the pulley bracket of FIGS. 2 and 3 shown with the improved pulley of FIGS. 4 and 5, according to one embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments of fall protection tripod pulley improvements for different types of cables, as well as operation and/or component parts thereof While the following description will be described in terms of tripod pulley improvements for different types of cables, systems and devices for clarity and to place the invention in context, it should be kept in mind that the teachings herein may have broad application to all types of systems, devices and applications.

Some embodiments relate to fall protection equipment including tripod pulley improvements for different types of cables. One embodiment of the invention provides A pulley system for a confined space tripod includes a pulley including a pulley cavity having a first width and a second width. A pulley safety bracket is attached with the pulley. The pulley safety bracket includes a removable detent pin configured for placement above the pulley that prevents a pulley cable from dislodging from the pulley.

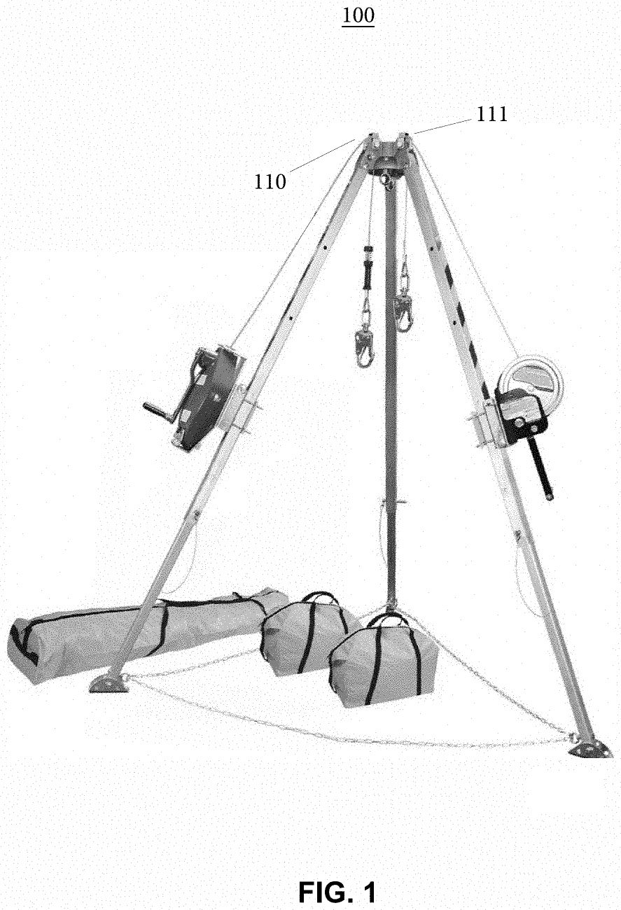

FIG. 1 illustrates a tripod anchor system 100 including an SRL connected to a first pulley 110 and a winch connected to a second pulley 111. A typical confined space application involves setting up the tripod anchor system 100 over an entry port, equipped with entry/egress, fall protection, and rescue devices i.e., personnel and material winches, 3-way SRL-R winch devices, a Self-Retracting Device (SRD) and a Fall Arrester Connecting Subsystem (FACSS). Typically there are two operators of a tripod anchor system 100 with a device: 1) the entrant who is equipped with an approved full body harness and remains attached to a lifeline, and 2) the attendant, who cranks the winch, directs the cable, and maintains constant contact with the entrant, either visually or by other means. The tripod anchor system 100 may typically have a 60 foot (ft) galvanized steel cable, an SRL-R and a personnel winch, leg brackets and leg safety chain. The tripod anchor system 100 may include 2-stage telescoping legs with 5-8 ft height adjustment.

Each device attached to the tripod anchor system 100 has a certain functional configuration. The personnel winch is a manually operated raising and lowering device that must be cranked in both directions. The 3-way device is a fall protection SRD with a rescue function. Confined space operations may be described and planned for according to how the entry/egress will be accomplished using what equipment. Confined space entry uses the tripod anchor system 100 with only a single winch. A ladder is the primary method of entry and egress, and the winch is a backup device, for emergency retrieval and fall protection device. Since the winch lacks an energy absorber, it requires an attendant at all times to keep the device lifeline tensioned, to prevent fall protection loads from impacting it. A 3-way SRL-R (an SRL with rescue capability) is not intended as an everyday raising and lowering winch and must not be used as a primary entry and egress device. When used with a fall protection device, the tripod anchor system 100 is rated for one worker weighing a maximum of 310 lbs. (140 kg) (including all clothing, tools, and equipment). For emergency retrieval applications, more than one person may be attached to the tripod anchor system 100. For rescue purposes, devices may be mounted in any manner and place that would facilitate the rescue.

The tripod anchor system 100 is primarily for those entering and working in confined spaces, both Permit and Non-Permit. The Occupational Safety and Health Administration (OSHA) defines a confined space as any space with limited openings for entry or exit, is large enough for a worker to enter bodily and perform work, and is not designed for continuous worker occupancy. Confined spaces include but are not limited to, tanks, storage bins, manholes, pits, silos, underground utility vaults and pipelines. Permit-required confined spaces are confined spaces that, in addition to having limited entry/egress, also contain some type of hazard, either environmental or atmospheric, unguarded machinery, exposed electrical components, engulfment hazards, or a downward sloping tapered shape.

The tripod anchor system 100 provides the support structure for entry and egress for rescue/evacuation systems, and is the anchorage for fall protection, work positioning, and personnel riding systems. The tripod anchor system 100 is composed of a cast aluminum head assembly, equipped with integrated aluminum pulleys (first pulley 110 and second pulley 111) and pulley guards for rescue and retrieval device cables and two eyebolts for attaching at least one personal fall arrester system (PFAS). The legs of the tripod anchor system 100 are 2-part telescoping square aluminum tube, secured to specified length by pins. Brackets to facilitate the use of entry/egress, lower/hoist personnel winches, and 3-Way SRL-R fall protection devices are installed on the legs. The feet are auto-leveling and are equipped with a spiked edge for soft ground and rubber pads for hard surfaces. Eyebolts in the lower leg portions facilitate the use of a safety chain to prevent the tripod legs from splaying out under loads when the tripod is in use.

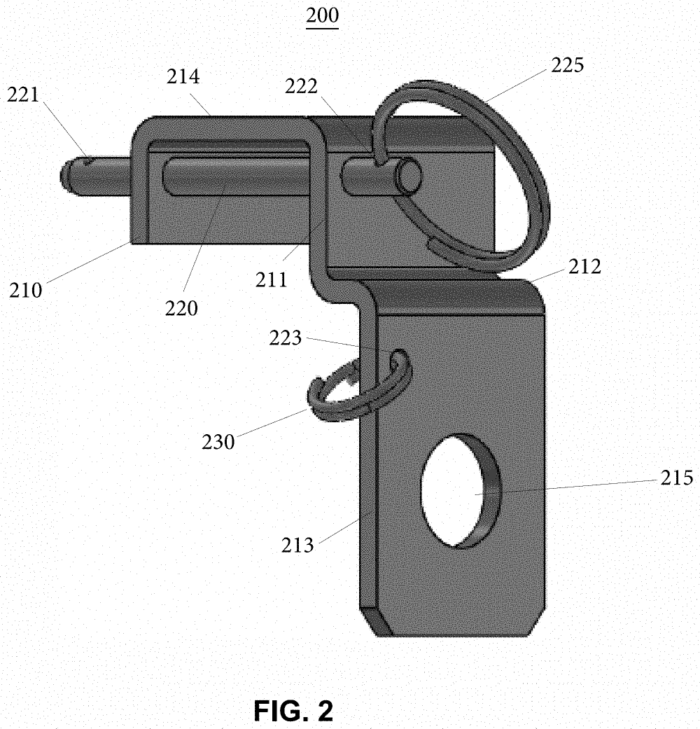

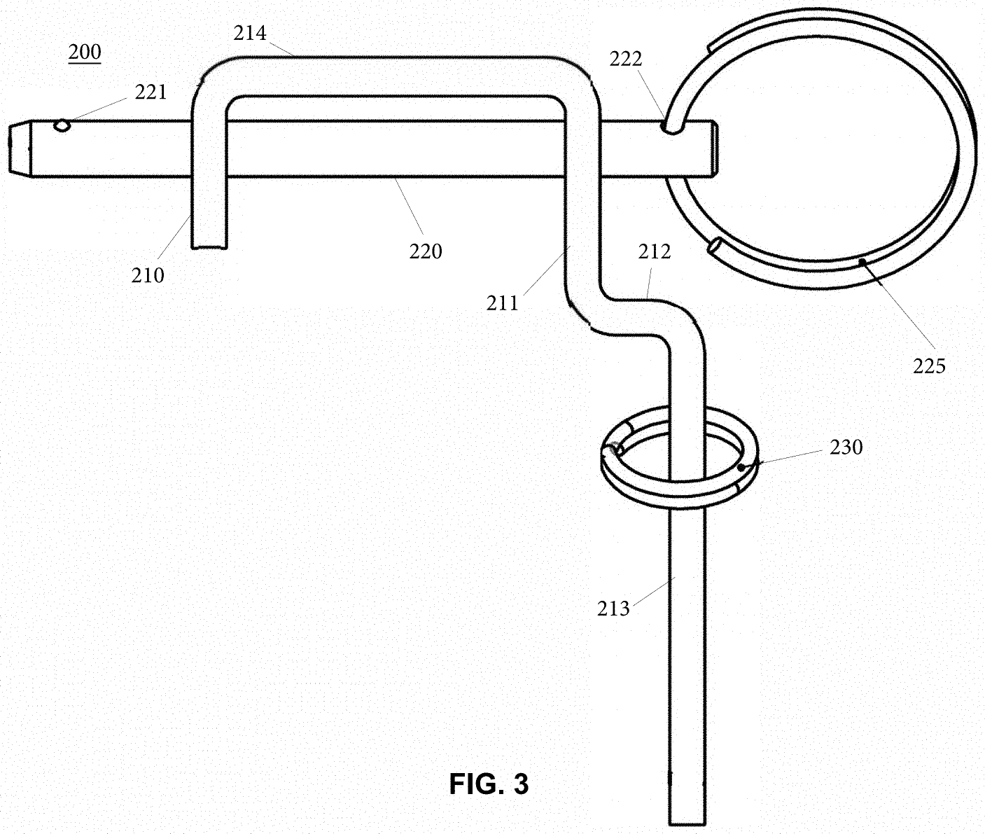

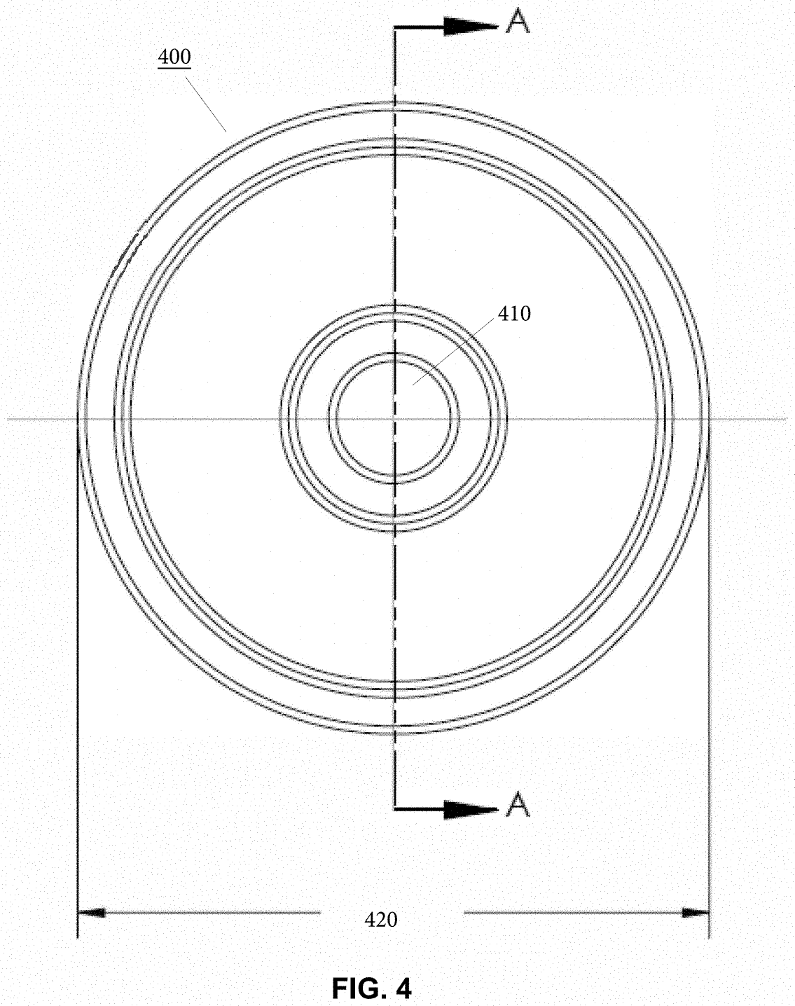

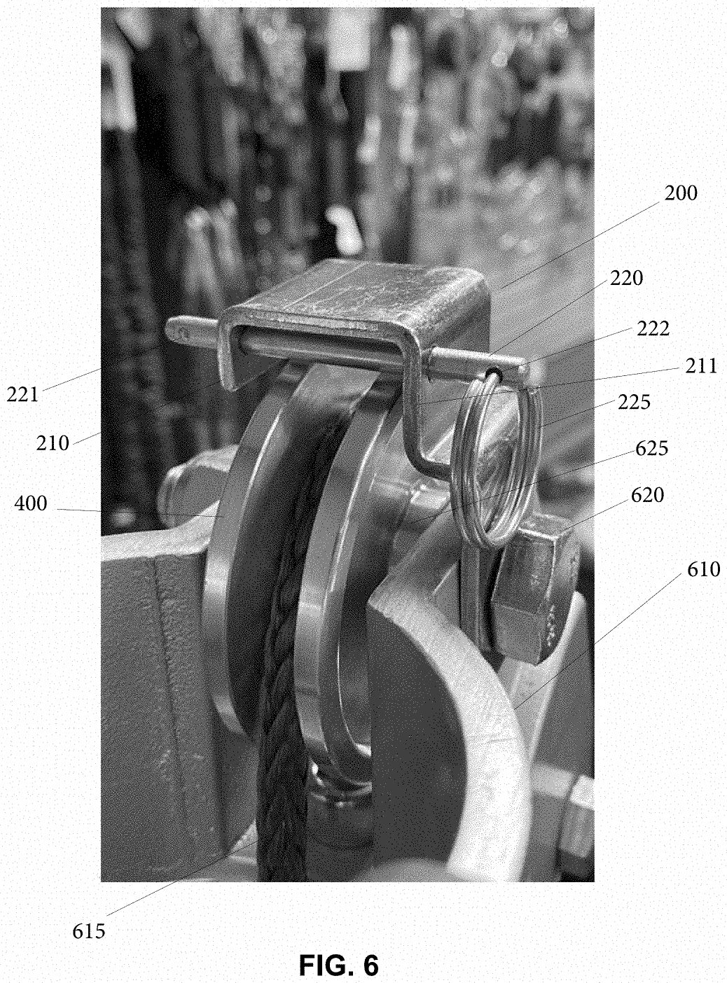

FIG. 2 illustrates a perspective view of a pulley bracket (or cable guard) 200 with a removable detent pin 220, according to one embodiment of the invention. FIG. 3 illustrates a front view of the pulley bracket 200 with the removable detent pin 220 of FIG. 2, according to one embodiment of the invention. In some embodiments, the pulley bracket 200 includes a first portion 210 including a first through-hole for the removable detent pin 220 (e.g., 3/16 in. diameter, etc.), a second portion 211 including a second through-hole for the removable detent pin 220, a third portion 212 that spaces the cable guard portion 214 over a pulley 400 (FIGS. 4-6), and a fourth portion 213 including a fastening through-hole 215 for fastening the pulley bracket 200 to a tripod (e.g., the tripod anchor system 100, FIG. 1) with a bolt 620 (FIG. 6), machine screw, etc. In some embodiments, the detent pin 220 includes a spring-loaded ball bearing 221 (or equivalent) that assists in preventing the removable detent pin 220 from sliding out of the first through-hole in the first portion 210. Alternatively, the spring-loaded ball bearing 221 may be replaced with a through-hole where a retaining ring, retaining pin, bolt, etc. may be inserted to prevent the removable detent pin 220 from inadvertent sliding out of the first through-hole in the first portion 210. The removable detent pin 220 includes a through-hole 222 for insertion of a retaining ring 225, which is made of a metal or metal-alloy. In one embodiment, the retaining ring 225 may be made of galvanized wire rope (e.g., 7/16 in. internal diameter, etc.) that is split for insertion and removal from the through-hole 222. The fourth portion 213 further includes a through-hole 223 for insertion of a retaining ring 230, which may be used for connecting to the retaining ring 225 when the removable detent pin 220 is removed from the pulley bracket 200.

In one embodiment, the pulley 400 receives a metal or metal alloy cable (e.g., 3/64 in. diameter, 7×7 galvanized wire rope, etc.) or may be fitted with a material rope 615 (FIG. 6; e.g., nylon, etc.). One issue with using a material rope 615 with the pulley 400 is that due to the material slack and diameter, etc., it may tend to exit over the pulley 400 and jam or become wedged between the pulley bracket 200 and a portion of the external portion of the pulley 400. In order to prevent the material rope 615 from becoming dislodged from the pulley 400, the removable detent pin 220 is used when the material rope 615 is deployed with pulley 400.

FIG. 4 illustrates a side view of an improved pulley 400 that is employed with the pulley bracket 200 of FIGS. 2 and 3, according to one embodiment of the invention. In one embodiment, the pulley 400 has an outer diameter 420 of 78 mm, and an inner diameter 410 (for a through-hole) of 14.1 mm (sized to fit therethrough the fastener 620 within the opening, FIG. 6). In other embodiments, the inner diameter 410 and out diameter 420 may change in sizing dependent on the desired requirements.

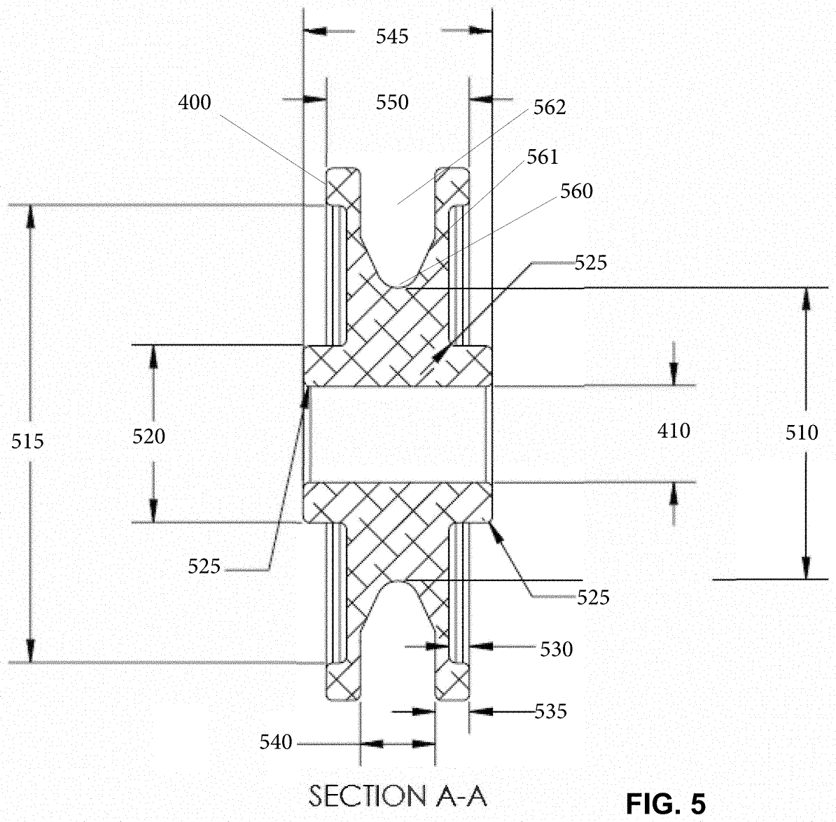

FIG. 5 illustrates a view along section A-A of the improved pulley 400 of FIG. 4, according to one embodiment of the invention. In some embodiments, the pulley 400 includes an inner pulley distance 510 of about 43 mm from the lower cable groove 560 to the opposite side of section A-A. The lower cable groove 560 is curved and has a smaller width than the upper portion of the cavity 562 formed between the upper walls of the pulley 400. The lower cable groove 560 transitions to the larger width via the transition portion 561, which assists the pulley for maintaining a metal cable with a first diameter and a rope cable 615 (FIG. 6) with a second diameter that is larger than the first diameter. Therefore, the cavity 562, the transition portion 561 and the lower cable groove 560 provides for use of multiple cables of varying diameter.

In some embodiments, the pulley 400 has a distance 515 of about 67 mm., a distance 520 of about 26 mm., a typical cylinder shape 525 of the bracket connecting portions 625 (FIG. 6), pulley walls interior width 530 of about 3 mm., pulley walls upper portion width 535 of about 5 mm., inner diameter between pulley walls 540 of about 11 mm., outer diameter 545 between the outer portions of the bracket connecting portions 625 of about 27.70 mm., and distance 550 between the outer portion of the upper pulley walls of about 21 mm. In some embodiments, the pulley 400 is smoothed so as to remove any sharp edges (e.g., using grinding, sanding, milling, polishing, etc.).

FIG. 6 shows a photographic view of the pulley bracket 200 of FIGS. 2 and 3 shown with the improved pulley 400 of FIGS. 4 and 5, according to one embodiment of the invention. As shown, the pulley bracket 200 attaches to a tripod (e.g., a tripod similar to tripod 100, FIG. 1) using a pulley bracket 610 (e.g., made of a metal, metal alloy, aluminum, aluminum alloy, steel, etc.) through a through-hole sized to fit the attachment bolt (or similar fastener device) 620. The attachment bolt 620 is placed through fastening through-hole 215 (FIG. 2) of the pulley bracket 200 and then through the inner diameter 410 of the pulley 400 to the other side of the pulley 400 and then fastened (e.g., using a washer or a locking washer and an appropriately sized nut) appropriately to provide for free spinning of the pulley 400.

In some embodiments, when the pulley 400 cable is made of wire rope, the detent pin 220 may be removed or may be left in place if desired for added safety. When the cable is replaced with a rope (e.g., made of a polymer, nylon, manila, polyester, polypropylene, Kevlar, etc.), the detent pin 220 is placed into the pulley bracket 200 to ensure that the rope cable does not spin out of the pulley 400 when in use as an additional safety precaution. The height of the detent pin 220 over the cable retaining walls of the pulley 400 is such that the detent pin 220 does not come into contact with the upper surface of the cable retaining walls of the pulley 400. The width of the cable guard portion 214 provides enough space to overhang the first portion 210 and the second portion 211 a distance outside the cable retaining walls of the pulley 400 so as not to interfere with the operation of the pulley 400.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional elements.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A pulley system for a confined space tripod comprising:
a pulley including a pulley cavity having a first width and a second width; and
a pulley safety bracket coupled with the pulley, the pulley safety bracket including a removable detent pin configured for placement above the pulley that prevents a pulley cable from dislodging from the pulley.

2. The pulley system of claim 1, wherein the pulley safety bracket further comprises:
a first portion including a first through-hole for the removable detent pin; and
a second portion including a second through-hole for the removable detent pin.

3. The pulley system of claim 2, wherein the pulley safety bracket further comprises:
a cable guard portion; and
a third portion that is disposed over the removable detent pin.

4. The pulley system of claim 3, wherein the pulley safety bracket further comprises:
a fourth portion including a fastening through-hole for fastening the pulley safety bracket to a pulley fastening bracket.

5. The pulley system of claim 4, wherein the second width of the pulley cavity is greater than the first width of the pulley cavity.

6. The pulley system of claim 4, wherein the pulley includes a lower cable groove that is curved and has a smaller width than an upper portion of the pulley cavity that is disposed between upper walls of the pulley.

7. The pulley system of claim 6, wherein the lower cable groove transitions to a larger width via a transition portion, and the pulley with the pulley safety bracket is configured for maintaining a metal cable with a first diameter or a rope cable with a second diameter that is larger than the first diameter.

8. A pulley system for a confined space tripod comprising:
a pulley including a pulley cavity that is disposed between upper walls of the pulley, the pulley cavity including a lower cable groove that is curved and increases in width toward an upper portion of the pulley cavity; and
a pulley safety bracket coupled with the pulley, the pulley safety bracket including a removable detent pin configured for placement above the pulley that prevents a pulley cable from dislodging from the pulley.

9. The pulley system of claim 8, wherein the pulley safety bracket further comprises:
a first portion including a first through-hole for the removable detent pin; and
a second portion including a second through-hole for the removable detent pin.

10. The pulley system of claim 9, wherein the pulley safety bracket further comprises:
a cable guard portion; and
a third portion that is disposed over the removable detent pin.

11. The pulley system of claim 10, wherein the pulley safety bracket further comprises:
a fourth portion including a fastening through-hole for fastening the pulley safety bracket to a pulley fastening bracket.

12. The pulley system of claim 11, wherein the pulley cavity has a first width and a second width, and the second width of the pulley cavity is greater than the first width of the pulley cavity.

13. The pulley system of claim 12, wherein the lower cable groove transitions to a larger width via a transition portion, and the pulley with the pulley safety bracket is configured for maintaining a metal cable with a first diameter or a rope cable with a second diameter that is larger than the first diameter.

14. A pulley system for a confined space tripod comprising:
a pulley including a pulley cavity that is disposed between upper walls of the pulley, the pulley cavity including a lower cable groove that is curved and increases in width toward an upper portion of the pulley cavity;
a pulley safety bracket coupled with the pulley, the pulley safety bracket including a removable detent pin configured for placement above the pulley that prevents a pulley cable from dislodging from the pulley; and
a confined space tripod coupled to a fastening bracket, the pulley and the pulley safety bracket.

15. The pulley system of claim 14, wherein the pulley safety bracket further comprises:
a first portion including a first through-hole for the removable detent pin; and
a second portion including a second through-hole for the removable detent pin.

16. The pulley system of claim 15, wherein the pulley safety bracket further comprises:
a cable guard portion; and
a third portion that is disposed over the removable detent pin.

17. The pulley system of claim 16, wherein the pulley safety bracket further comprises:
a fourth portion including a fastening through-hole for fastening the pulley safety bracket to a pulley fastening bracket.

18. The pulley system of claim 17, wherein the pulley cavity has a first width and a second width, and the second width of the pulley cavity is greater than the first width of the pulley cavity.

19. The pulley system of claim 18, wherein the lower cable groove transitions to a larger width via a transition portion, and the pulley with the pulley safety bracket is configured for maintaining a metal cable with a first diameter or a rope cable with a second diameter that is larger than the first diameter.
